(19) United States
(12) Patent Application Publication
(10) Pub. No.: US 2025/0088589 A1
(43) Pub. Date: Mar. 13, 2025

(54) INTERACTIVE SYSTEM COMBINING AUTOMATED VOICE MECHANISM WITH VISUAL FEEDBACK MECHANISM AND INTERACTIVE METHOD THEREOF

(71) Applicant: Dynalab Global Pte. Ltd.

(72) Inventors: Chen-Yin Lee, Taipei City (TW); Yu-Ping Wei, Taipei City (TW)

(73) Assignee: Dynalab Global Pte. Ltd., (omitted)

(21) Appl. No.: 18/817,230

(22) Filed: Aug. 28, 2024

(30) Foreign Application Priority Data
Sep. 13, 2023 (TW) 112134960

(51) Int. Cl. H04M 3/493; H04M 7/12

(52) U.S. Cl. CPC H04M 3/4936; H04M 3/4938; H04M 7/1205

(57) ABSTRACT

An interactive system combines an automated voice mechanism with a visual feedback mechanism. A first terminal device and a telecommunications server mutually transmit messages through a public switched telephone network. The first terminal device can send an input message to the telecommunications server and receive a voice feedback message from the telecommunications server. The telecommunications server can generate a processing message based on the input message and transmit the processing message to an information management server which based on the processing message's content, through an internet sends a forward message to an information distribution server which based on the forward message's content, sends a control message to a second terminal device. The second terminal device transmits a request message to a picture content management server according to the forward message to obtain a picture feedback message returned by the picture content management server. Accordingly, a user can simultaneously have voice and visual guidance for choice-making.

### CROSS-REFERENCE TO RELATED PATENT APPLICATION

This non-provisional application claims priority to and the benefit of, under 35 U.S.C. § 119 (a), Taiwan Patent Application No. 112134960, filed Sep. 13, 2023 in Taiwan. The entire content of the above identified application is incorporated herein by reference.

### FIELD

The present disclosure is related to an interactive system, and more particularly to an interactive system combining an automated voice mechanism with a visual feedback mechanism and an interactive method thereof, so that a user can, while operating a first terminal device and listening to the voice information sent from the first terminal device, watch the picture information matching said voice information on a second terminal device.

### BACKGROUND

An interactive voice response (IVR) system, also called automated voice response system, allows a user to interact through telephone with a corresponding telecommunications host that is at a service provider's end. When a user calls out to the corresponding telecommunications host and enters an IVR system, the IVR system can play a series of pre-recorded voice content. The user can press the key(s) on a telephone as his or her response according to the voice guidance heard, so as to obtain needed information or accomplish specific operation (for example, activating a credit card).

IVR-system related technologies have been applied to many industries. For example, many banks and service providers use IVR systems to provide 24-hour customer service, and users can check their account balances, pay bills, transfer funds, or perform other operations at any time. Airlines, travel agencies and medical institutions also use IVR systems to allow users to check flight information, book tickets, confirm appointment times, etc. It therefore can be known from the above that IVR systems have many advantages. One of their most prominent advantages is that IVR systems greatly increase service efficiency and accessibility. Through automated operation, service providers can at any time and anywhere provide service to users without manual intervention, which not only saves on human resources but also ensures information accuracy and immediacy, lessening user wait time and increasing client satisfaction.

However, despite clear advantages in providing diversified and highly-efficient service, there is still room for improvement for IVR systems, especially in aspects related to specific user groups. In fact, for users of advanced age or with poor hearing, IVR systems that rely entirely on voice are not friendly. Pre-recorded voice messages could have problems such as distortion, insufficient clarity, etc. during transmission, making it difficult for such users to understand the voice content and perform operation according to voice guidance. People of advanced age may sometimes miss important instructions due to improper operation or slow reaction. The above-referenced situations can cause confusion to users, which in turn affects their use experience. Additionally, most IVR systems have specific response time limits. If the user fails to make a choice or response within the limited time, the IVR system may automatically end the call. This situation no doubt would exert pressure on users of advanced age who need more time to handle information or make decisions, making it inconvenient for them to use IVR systems, and making them feel unpleasant when using IVR systems.

Research institutes and the industry have begun searching for solutions to the above-referenced issues. Some service providers optimize voice quality, make play speed adjustable, adjust response time according to user needs, etc., so as to improve user experience. However, for users of advanced age or with poor hearing, when voice guidance does not function for them, they usually choose to be transferred to human client service. As service provides use IVR systems on the premise of saving human resource spending, the afore-referenced users can spend more time waiting for human client service, causing lower user experience and satisfaction. Accordingly, one of the issues addressed in the present disclosure is to effectively solve the afore-referenced problems.

### SUMMARY

In view of the fact that traditional IVR systems can only provide voice guiding functions, which obviously is not friendly enough for some users, based on the research spirit that strives for excellency, as the result of longtime hard research and experiments, an interactive system that combines an automated voice mechanism with a visual feedback mechanism and its interactive method are provided in the present disclosure, so as to provide visual and voice multi-guidance at the same time, ensuring that the most users can clearly understand guiding information, lessening misunderstanding and helping users to make correct choices.

Certain aspects of the present disclosure are directed to an interactive system combining an automated voice mechanism with a visual feedback mechanism. The interactive system includes a first terminal device, a telecommunications server, an information management server, an information distribution server, a second terminal device and a picture content management server. The first terminal device is connectable to a public switched telephone network (PSTN) and has a user input interface. The user input interface is configured to generate an input message according to operation of a user, and the input message includes a piece of input information. The telecommunications server is connectable to a voice database and configured to: receive the input message sent from the first terminal device through the PSTN; generate a processing message corresponding to the input message according to the input message, with the processing message including a first identification code representing the first terminal device and a piece of interaction information corresponding to the input information; retrieve at least one piece of pre-recorded voice fragment information from the voice database according to contents of the input message; generate a voice feedback message according to the pre-recorded voice fragment information; and send the voice feedback message to the first terminal device through the PSTN. The information management server is connectable to the telecommunications server and a user database, and configured to: receive the processing message sent by the telecommunications server; retrieve a piece of user information from the user database according to the first identification code in the processing message; and generate a forward message. The forward message includes the user information and the interaction information. The information distribution server is connectable to the information management server through an internet and configured to: receive the forward message sent by the information management server; and send a control message to the corresponding second terminal device according to the user information in the forward message. The control message includes the interaction information. The second terminal device is configured to receive the control message through the internet from the information distribution server and generate a request message. The request message includes a second identification code and the interaction information. The picture content management server is connectable to a picture database and configured to: receive the request message from the second terminal device through the internet; retrieve at least one piece of picture information from the picture database according to the interaction information in the request message; generate a picture feedback message according to the picture information; and send the picture feedback message to the second terminal device through the internet. In this way, providing both voice and visual guidance prompts for users with special needs can ensure that users quickly obtain and understand the aforementioned guidance prompt information, reduce the risk of user errors, and help users make the right choice to obtain the need information.

In certain embodiments, the interactive system further includes a voice editing tool configured to edit pre-recorded voice fragment information in the voice database and input information corresponding to the pre-recorded voice fragment information in the voice database.

In certain embodiments, the interactive system further includes a picture editing tool configured to edit picture information in the picture database and interaction information corresponding to the picture information in the picture database.

In certain embodiments, the first terminal device and the second terminal device are the same piece of equipment.

In certain embodiments, the voice database is in the telecommunications server.

In certain embodiments, the telecommunications server is installed with a voice recognition module.

In certain embodiments, the picture database is in the picture content management server.

Certain aspects of the present disclosure are directed to an interactive method of an interactive system combining an automated voice mechanism with a visual feedback mechanism. The interactive system includes a first terminal device, a telecommunications server, an information management server, an information distribution server, a second terminal device and a picture content management server. The interactive method includes steps of: receiving, by the telecommunications server, an input message sent from the first terminal device through a PSTN, and generating, by the telecommunications server, a processing message corresponding to the input message, with the processing message including a first identification code and a piece of interaction information; retrieving, by the telecommunications server, at least one piece of pre-recorded voice fragment information from a voice database according to the processing message to generate a voice feedback message, sending, by the telecommunications server, the voice feedback message to the first terminal device through the PSTN, and sending, by the telecommunications server, the processing message to the information management server through an internet; receiving, by the information management server, the processing message from the telecommunications server, retrieving, by the information management server, a piece of user information from a user database according to the first identification code in the processing message, generating, by the information management server, a forward message, and sending, by the information management server, the forward message to the information distribution server through the internet, with the forward message including the user information and the interaction information; receiving, by the information distribution server, the forward message sent from the information management server, generating, by the information distribution server, a control message according to the user information in the forward message, and sending, by the information distribution server, the control message to the second terminal device through the internet, with the control message including the interaction information, and the second terminal device being configured to generate a request message according to the control message; and receiving, by the picture content management server, the request message sent from the second terminal device through the internet, retrieving, by the picture content management server, at least one piece of picture information from a picture database according to the interaction information in the request message to generate a picture feedback message, and sending, by the picture content management server, the picture feedback message to the second terminal device through the internet. In this way, the interactive method in the present disclosure can provide voice and visual information at the same time to enhance the user's understanding of the guidance prompt information. Also, it is possible that certain guiding notices by nature are more intuitive when displayed visually, while certain other guiding notices by nature are neater when announced by voice. Accordingly, the overall efficiency in user use and operation can be increased.

In certain embodiments, the first identification code corresponds to the first terminal device, the interaction information corresponds to a piece of input information in the processing message, and the input information is generated after a user operates the first terminal device.

In certain embodiments, the first terminal device and the second terminal device are the same piece of equipment.

In certain embodiments, the information management server stops generating and sending the forward message after the information management server does not retrieve the corresponding user information from the user database according to the first identification code in the processing message.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of the system structure of an interactive system according to certain embodiments of the present disclosure.

FIG. 2 is a sequence diagram of an interactive method according to certain embodiments of the present disclosure.

FIG. 3 is a schematic diagram of a picture on a second terminal device according to certain embodiments of the present disclosure.

FIG. 4 is a schematic diagram of another picture on the second terminal device according to certain embodiments of the present disclosure.

FIG. 5 is a schematic diagram of yet another picture on the second terminal device according to certain embodiments of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The accompanying drawings are schematic and may not have been drawn to scale. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, materials, objects, or the like, which are for distinguishing one component/material/object from another one only, and are not intended to, nor should be construed to impose any substantive limitations on the components, materials, objects, or the like.

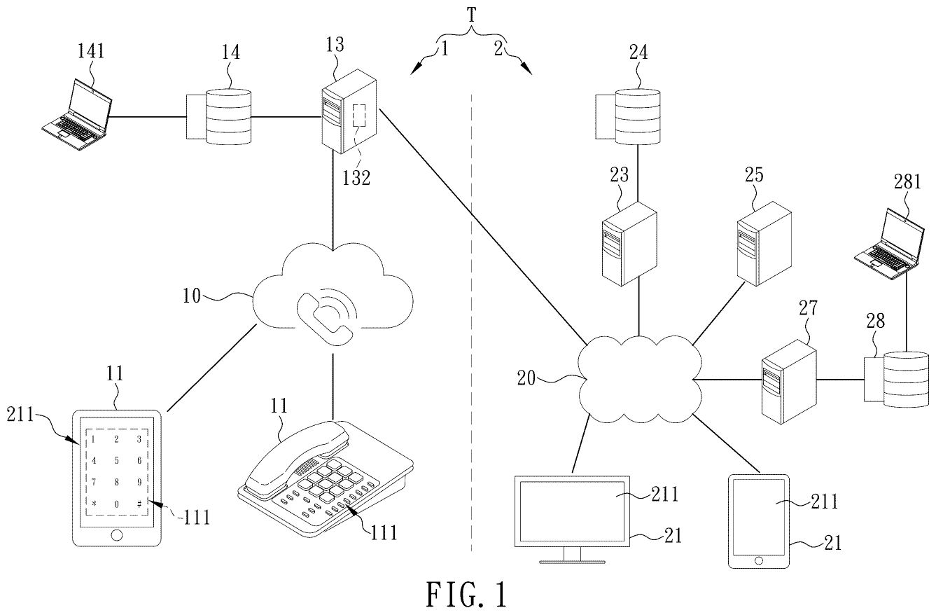

Certain aspects of the present disclosure are directed to an interactive system combining an automated voice mechanism with a visual feedback mechanism and an interactive method thereof. Referring to FIG. 1, an interactive system T includes an automated voice system 1 and a visual feedback system 2. The automated voice system 1 has an automated voice mechanism so as to provide users with voice feedbacks. The visual feedback system 2 has a visual feedback mechanism so as to provide users with visual feedbacks. In certain embodiments, the automated voice system 1 can be an IVR system that allows a user to dial a phone number designated by a service provider, so as to access a telecommunications host at the service provider's end, and the user can press one or more specific keys to listen to pre-recorded voice content and obtain needed information.

Referring to FIG. 1, the automated voice system 1 includes a first terminal device 11 and a telecommunications server 13. The first terminal device 11 can be a fixed-line telephone or a piece of mobile communication equipment (such as a mobile phone, a smart phone, etc.), which can be directly or indirectly connected to a public switched telephone network (PSTN) 10 to exchange information (call data) with the telecommunications server 13. The mobile communication equipment can first establish a wireless connection between the mobile communication equipment and the local telecommunications tower through a mobile communication network (such as 4G or 5G), and afterwards the mobile communication equipment still exchanges information with the telecommunications server 13 via the PSTN 10.

Referring again to FIG. 1, the first terminal device 11 has a user input interface 111 (such as physical keys/buttons, touch screen, microphone, etc.), and the first terminal device 11 can generate an input message based on the result of the user operating the user input interface 111, and transmit the input message to the telecommunications server 13. When the first terminal device 11 has not established a call with the telecommunications server 13, the input message is a call request, which includes a first identification code (such as a phone number) and a piece of input information. The input information can be a null value, and in certain embodiments, the call request can only have the first identification code (for example, a telephone number), which is equivalent to the input information being a null value. Further, when the first terminal device 11 has established a call with the telecommunications server 13, according to the specific configuration (such as being a fixed-line telephone) and the technology used thereby, the input message can have only the input information (such as the key/button information).

Referring again to FIG. 1, the first identification code is for identifying the call partner to ensure that the first terminal device 11 establishes a correct call with the telecommunications server 13. The telecommunications server 13 can transmit call data (such as voice content) to the corresponding first terminal device 11. The first identification code can be a telephone number, an international mobile subscriber identity (IMSI), an international mobile equipment identity (IMEI) or other unique identifier(s) sufficient for the telecommunications server 13 to identify it and maintains the call. The input information can be key information, voice information, null value, etc. When the user input interface 111 is physical keys/buttons or virtual keys/buttons, the input information is the key/button information of the physical/virtual key(s)/button(s) pressed by the user. When the user input interface 111 is a microphone, the input information is the voice command spoken by the user.

It is hereby noted that referring again to FIG. 1, when a user uses the automated voice system 1, there are two situations, that is, the user calls the carrier end (inbound) and the carrier end calls the user (outbound), respectively. Taking the user's calling the carrier end (inbound) as an example, the user will first dial the carrier end's phone number through the first terminal device 11, and this process is equivalent to the first terminal device 11 sending an input message (call request) to the telecommunications server 13, and the call request includes a first identification code (such as the phone number). Further, the telecommunications server 13 can establish a session according to the first identification code. Afterwards, the user can time by time press the physical or virtual key(s) or orally give the voice instruction(s) according to the respective voice content heard by him or her. When the call continues, the first terminal device 11 will only transmit key/button information or voice commands to the telecommunications server 13 without repeatedly transmitting the phone number, IMSI or IMEI. However, in order to ensure the accuracy of the call between the first terminal device 11 and the telecommunications server 13, the call process between the first terminal device 11 and the telecommunications server 13 can include a unique identifier corresponding to the session. The unique identifier of the session is an identifier generated by the telecommunications server 13 and used to track the call. The first identification code is for the telecommunication server 13 to accurately establish a correct call with the first terminal device 11, and any information related to the aforementioned effect can be regarded as the first identification code. Therefore, during the call, the specific form of the first identification code may change (for example, from a phone number to a unique identifier of the session), but its meaning remains unchanged (all representing the first terminal device 11 as the source).

Referring again to FIG. 1, when the use scenario is that the carrier end calls the user (outbound), it means that the telecommunications server 13 has obtained the first identification code (such as a phone number) of the first terminal device 11 in advance, and after the telecommunications server 13 establishes a call with the first terminal device 11, the input message sent from the first terminal device 11 can be received. The input message includes a piece of input information, for example, the user time by time presses the physical or virtual key(s) or orally gives the voice instruction(s) according to the respective voice content heard by him or her. In addition, in certain embodiments, the user input interface 111 is not limited to a single device, but can include multiple devices. For example, the user input interface 111 includes a touch screen and a microphone, and can generate the corresponding input message according to the user's operating context. For example, during the same call phase, the user can first press the virtual keys/buttons of the smartphone to generate key/button information, and then verbally speak voice commands to the microphone.

Referring again to FIG. 1, the telecommunications server 13 can receive the input message from the first terminal device 11 and can read the content of the input message. The telecommunications server 13 can obtain at least one piece of pre-recorded voice segment information from a voice database 14 according to the content of the input message to generate a voice feedback message, and can transmit the voice feedback message through the PSTN 10 back to the first terminal device 11. For example, when the first terminal device 11 has not established a call with the telecommunications server 13 and the telecommunications server 13 determines that the input information is a null value, the telecommunications server 13 can obtain the corresponding pre-recorded voice segment information from the voice database 14. For example, the pre-recorded voice segment information can be “Thank you for your call, for Mandarin service, please press 1; for English service, please press 2”, etc. Afterwards, the telecommunications server 13 will send the voice feedback message containing the aforementioned pre-recorded voice segment information to the first terminal device 11 so that the user can hear the aforementioned voice content.

Referring again to FIG. 1, during a call, after a user hear the voice content of “for balance check, please press 1; for transaction details, please press 2 . . . ”, etc., the user can press the key/button “1” of the physical key/button or the virtual key/button, or can verbally speak a voice command such as “1” or “balance check”, and the first terminal device 11 can send the input message containing the aforementioned input information to the telecommunications server 13. The telecommunications server 13 can, based on the input information (such as the key/button information or voice command equivalent to “1”), obtain relevant information from a corresponding database or other server (such as a financial database or server where user balance information can be obtained); based on the content of the relevant information, retrieve the corresponding pre-recorded voice segment information from the voice database 14 to generate a voice feedback message; and then send the voice feedback message to the first terminal device 11 so that the user can hear the voice content of the voice feedback message through the first terminal device 11, for example, the balance is XXXXX dollars.

Referring again to FIG. 1, in certain embodiments, the voice database 14 can be located in the telecommunications server 13. In certain embodiments, the voice database 14 can be located in another server. In certain embodiments, there can also be a voice editing tool 141 in the telecommunications server 13 or another device. The voice editing tool 141 is principally for editing data in the voice database, and/or the input information (for example, the key information of the physical key “1”, the voice information of the spoken “1” by a user, etc.) respectively corresponding to pieces of pre-recorded voice fragment information. In certain embodiments, the telecommunications server 13 can be installed with a voice recognition module 132 to obtain the user's spoken content and convert it into text (but not limited thereto).

Referring again to FIG. 1, the telecommunications server 13 can generate a corresponding processing message according to the content of the input message, and transmit the processing message to the visual feedback system 2 through an internet 20. The processing message at least includes the first identification code (such as a phone number) and a piece of interaction information corresponding to the input information. The content of the interaction information can be the same as the input information, or can be content that is sufficiently representative of the input information. For example, the interaction information can be the key/button information of the physical key “1”, the voice command of “1” spoken by the user, etc. Or, after the telecommunications server 13 receives the voice command of “1” spoken by the user, the telecommunications server 13 converts it into the information content such as “balance check” or “button 1”, etc. In other words, the telecommunications server 13 can directly use the input information as interaction information, or process the input information first to convert it into corresponding interaction information.

Referring again to FIG. 1, the visual feedback system 2 includes a second terminal device 21, an information management server 23, an information distribution server 25 and a picture content management server 27. The second terminal device 21 is a device with a display screen, such as an internet TV, a smart phone, etc. In certain embodiments, the second terminal device 21 can be a complex including plural pieces of equipment, for example, a set-top box and a television. In certain embodiments, the second terminal device 21 and the first terminal device 11 can be the same piece of equipment (such as a smart phone). The main reason is that a smart phone has functions such as dialing and display. For example, its touch screen can be used as the display screen 211, and virtual keys/buttons can also be displayed on it as the user input interface 111 (as the smartphone shown in the automated voice system 1 in FIG. 1), and the smart phone also has the ability to connect to the PSTN 10 and the Internet 20. Therefore, when the smart phone plays the role of the automated voice system 1, it can transmit information directly or indirectly through the PSTN 10. When the smart phone plays the role of the visual feedback system 2, it transmits information through the internet 20.

Referring again to FIG. 1, the information management server 23 is connected to the telecommunications server 13 to receive the processing message(s) from the telecommunications server 13. The information management server 23 has a telephone access interface (TAI). The TAI is principally for establishing communication between the information management server 23 and the telecommunications server 13, so as to transmit data therebetween. In addition, the information management server 23 can connect to a user database 24. The user database 24 stores a plurality of user information tables, and a user information table at least stores user information such as the first identification code and at least one user identification code, etc. The user identification code can be associated (bound) with at least one first identification code and associated with a second terminal device 21 for the information management server 23 to identify the corresponding second terminal device 21 according to the user identification code and correctly transmit the message to the second terminal device 21. According to actual needs, the user identification code can be an embedded OS ID, such as an Android ID, Apple ID, SoC unique ID (Linux), etc., or it can also be an IP address, media access control (MAC) address, universally unique identifier (UUID), IMEI or IMSI, etc. In other words, the user identification code corresponds to the second terminal device 21 so that the message(s) from the information management server 23 can be correctly transmitted to the second terminal device 21. In addition, the information management server 23 can generate a forward message based on the processing message and the content of the user data table. The forward message includes at least part of user information (such as user identification code) and interaction information (such as key/button information of physical key/button “1”).

Referring again to FIG. 1, the information distribution server 25 can be connected to the information management server 23 through the internet 20 to receive the forward message sent from the information management server 23 and can generate a control message. The control message at least includes the interaction information. Further, the information distribution server 25 can transmit the control message to the corresponding second terminal device 21 through wired or wireless technology (such as wide area wireless technologies such as 3G, 4G, 5G, 6G, etc.) according to the content of the user information (such as user identification code). In certain embodiments, the information management server 23, the information distribution server 25 and the second terminal device 21 can use the message queuing telemetry transport (MQTT) communication protocols (but not limited thereto). The information management server 23 is equivalent to a message publisher, the information distribution server 25 is equivalent to a broker, and the second terminal device 21 is equivalent to a message subscriber, so as to transmit corresponding messages and information to each other. Further, the second terminal device 21 can generate a request message according to the content of the control message, and the request message at least includes a second identification code and the interaction information. The second identification code can be the same as or different from the user identification code (but not limited thereto), and can be an embedded OS ID, IP address, MAC address, UUID, IMEI, IMSI, etc. In addition, when the second terminal device 21 is a combination of a set-top box and an internet TV, assuming that the internet TV is in the powered-off state, after the set-top box receives the control message, the set-top box can first send a power-on message to make the internet TV to be in the powered-on state. For example, the set-top box can be provided with a power switch module, so that the internet TV can be changed to a powered-on state through the power switch module. However, the present disclosure is not limited thereto. In certain embodiments, depending on the different types of the second terminal device 21, it can have its own specific way of turning on the display screen 211 after receiving the control message. In certain embodiments, the user needs to turn on the display screen 211 of the second terminal device 21 by himself or herself to complete subsequent processes.

Referring again to FIG. 1, the picture content management server 27 can be connected to the second terminal device 21 through the internet 20 and can receive the request message(s) from the second terminal device 21. Further, the picture content management server 27 can retrieve at least one default picture information from a picture database 28 according to the interaction information of the request message to generate a picture feedback message. Afterwards, the picture content management server 27 can, according to the second identification code, transmit the picture feedback message back to the second terminal device 21 through the internet 20, so that the user can see the corresponding picture on the display screen 211 of the second terminal device 21, for example, a picture showing that the balance is XXXXX dollars. It can be known from such that the visual feedback system 2 can obtain the input message(s) (such as key/button information or voice commands) from the first terminal device 11 through the telecommunications server 13 to provide the corresponding picture(s) on the second terminal device 21. In this way, users, especially users of advanced age, can operate in a more familiar way (such as pressing the keys/buttons of a fixed-line phone), and in addition to hearing the voice content, can also directly see the picture(s), which greatly improves the convenience of use. It is noted that the picture content management server 27 is not limited to a single server, and can be a complex including plural servers based on actual needs. For example, when the content that the customer wants to know involves financial information, the picture content management server 27 can obtain relevant information from another corresponding server (such as a financial database or server where user balance information can be obtained), and according to the relevant information content, retrieve the corresponding default picture information from the picture database 28 to generate the picture feedback message(s).

Referring again to FIG. 1, in certain embodiments, the picture database 28 can be located in the picture content management server 27. In certain embodiments, the picture database 28 can be located in another server. In certain embodiments, there is also a picture editing tool 281 in the picture content management server 27 or another server. The picture editing tool 281 is mainly used to edit the data in the picture database 28 and/or the interaction information corresponding to each default picture information (such as the key/button information of the physical key/button “1”, the voice information of “1” spoken by the user, etc.).

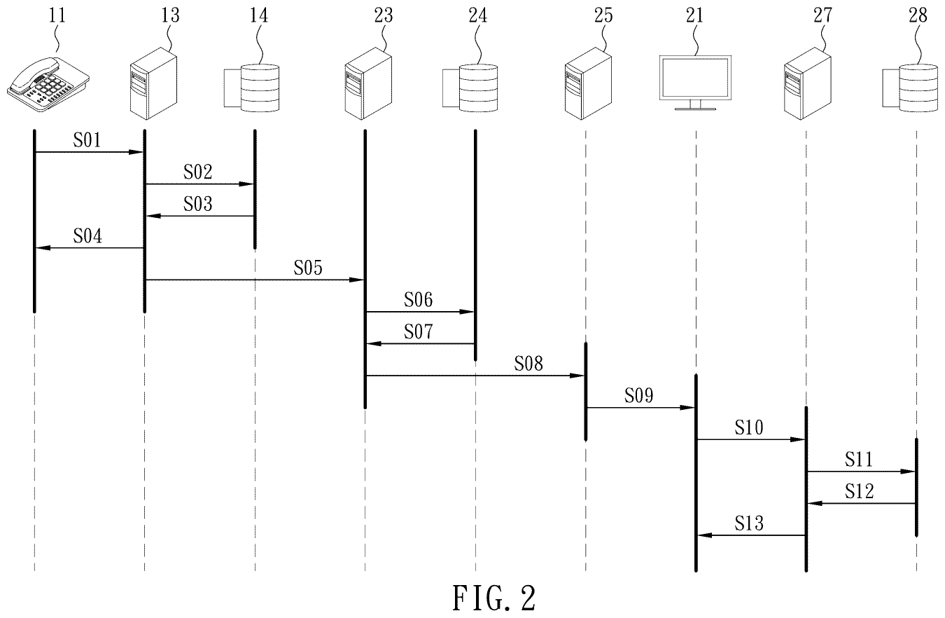

Referring to FIGS. 1 and 2, the interactive method involving the interactive system T according to the present disclosure is described as follows.

Step S01: The first terminal device 11 (such as a fixed-line phone) sends an input message to the telecommunications server 13, wherein when the first terminal device 11 has not established a call with the telecommunications server 13, the input message is a call request, so that the first terminal device 11 and the telecommunications server 13 can establish according thereto; and when the first terminal device 11 and the telecommunications server 13 have established a call, the input message can include input information such as key/button information, voice commands, etc.

Step S02: The telecommunications server 13 sends a search voice request to the voice database 14 according to the content of the input message from the first terminal device 11, wherein the search voice request can include the aforementioned input information.

Step S03: The voice database responds to the search voice request by sending back the corresponding pre-recorded voice fragment information, wherein when the input message is a call request, the pre-recorded voice fragment information can be greetings, for example, “Thank you for your call, for Mandarin service, please press 1; for English service, please press 2” (but not limited thereto); and when the input message includes input information such as key information, an voice instruction, etc. (for example, the option of “Mandarin service” has been chosen by a user), the pre-recorded voice fragment information is the corresponding voice content, for example, “for balance check, please press 1; for transaction details, please press 2”, etc. (but not limited thereto).

Step S04: The telecommunications server 13 converts the received pre-recorded voice segment information to generate a corresponding voice feedback message, and transmits the voice feedback message to the first terminal device 11. In this way, the user can hear the voice content corresponding to the voice feedback message through the first terminal device 11, for example, “Thank you for your call, for Mandarin service, please press 1; for English service, please press 2”, “for balance check, please press 1; for transaction details, please press 2”, etc.

Step S05: The telecommunications server 13 generates a corresponding processing message according to the input message, and sends the processing message to the information management server 23, wherein the processing message at least includes a first identification code and interaction information corresponding to the input information. In addition, Step S05 and Step S04 can have a reversed processing order or occur simultaneously.

Step S06: The information management server 23 sends a search user request to the user database 24 according to the content of the processing message, wherein the search user request can at least include a first identification code.

Step S07: The user database 24 sends back the corresponding user information table in response to the search user request, wherein each user information table is associated (bound) with a first identification code, and when the user data table corresponding to the first identification code cannot be found in the user database 24, it will respond with an error message to the information management server 23.

Step S08: The information management server 23 generates a corresponding forward message based on the processing message and the content of the user information table searched out, and sends the forward message to the information distribution server 25, wherein the forward message can include the interaction information and the user identification code in the user information table. In addition, when the information management server 23 receives the aforementioned error message, it will stop generating and sending the forward message. In this way, the user afterwards will only be able to use the services that the automated voice system 1 can provide and achieve.

Step S09: The information distribution server 25 generates a control message according to the content of the forward message, and sends the control message to the second terminal device 21 according to the user identification code in the forward message, wherein the control message at least includes the interaction information.

Step S10: The second terminal device 21 generates a request message according to the content of the control message, and sends the request message to the picture content management server 27, wherein the request message at least includes a second identification code and the interaction information.

Step S11: The picture content management server 27 sends a search picture request to the picture database 28 according to the content of the request message, wherein the search picture request can include the interaction information.

Step S12: The picture database 28 sends back the corresponding default picture information in response to the search picture request. Since the interaction information corresponds to the input information, the content of the default picture information can match the pre-recorded voice segment information received in Step S04.

Step S13: The picture content management server 27 converts the above-referenced obtained default picture information into the corresponding picture feedback message, and sends the picture feedback message to the second terminal device 21, so that the second terminal device 21 can display the picture on the display screen 211.

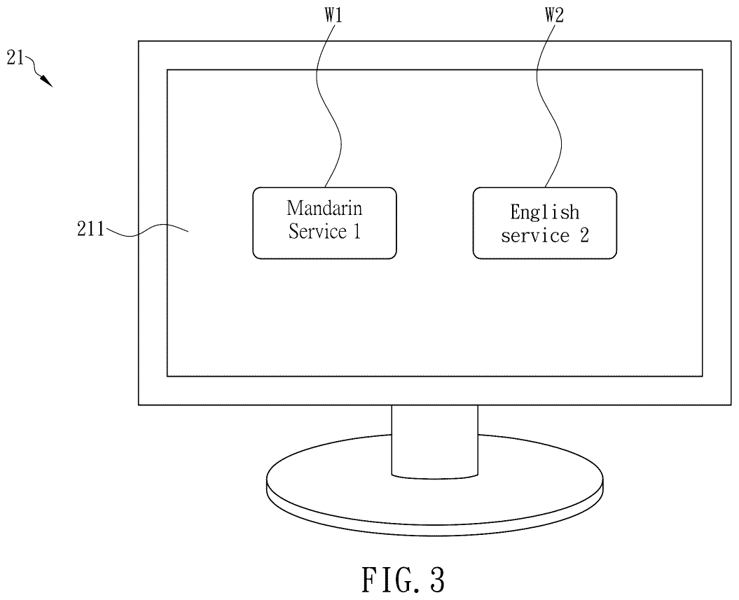

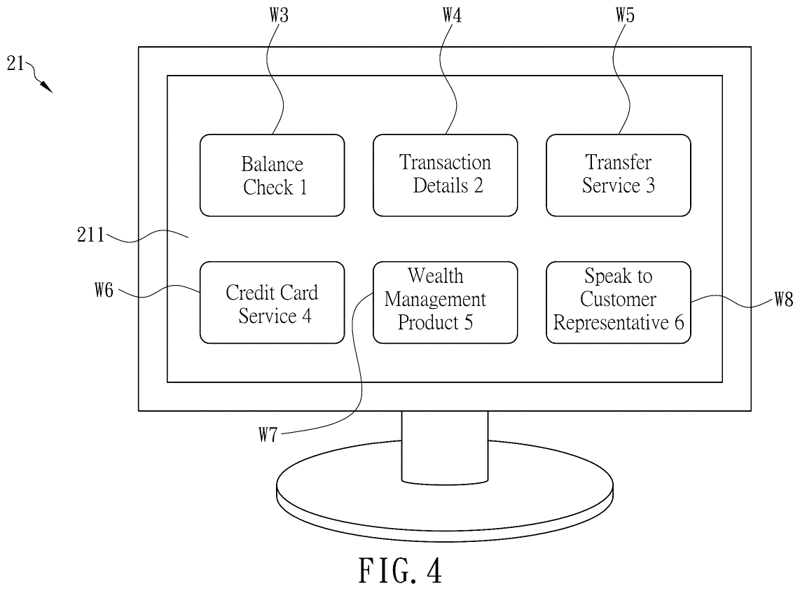

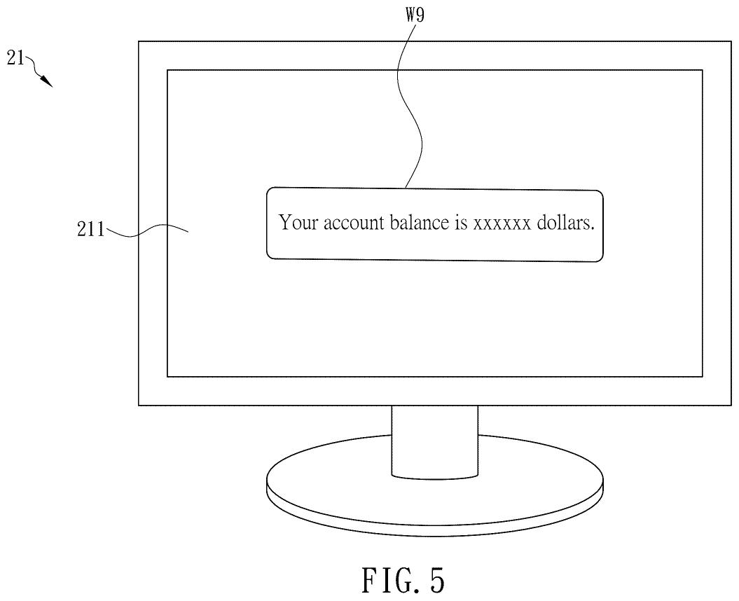

In summary of the above, referring again to FIGS. 1 and 2, through the interactive system T and the interactive method in the present disclosure, a user can obtain the experience results described as follows. When a user wants to check his or her bank balance, first, he or she can dial the bank's phone number using a fixed-line phone (first terminal device 11). After the call is established, the user can hear the voice content such as “Thank you for your call, for Mandarin service, please press 1; for English service, please press 2”, etc. on the fixed-line phone, and see the picture such as that in FIG. 3 being presented on the internet TV (second terminal device 21), which shows the image information W1, W2 of “Mandarin service 1” and “English service 2”. Afterwards, the user can press “Key/Button 1” of the physical key/button (user input interface 111), or dictates “1” or “Mandarin Service”. Further, the user can hear voice content such as “for balance check, please press 1; for transaction details, please press 2; for transfer service, please press 3; for credit card service, please press 4; for wealth management products, please press 5; to speak to a customer representative, please press 6”, etc. on the fixed-line phone, and see the picture such as that in FIG. 4 through the internet TV, which shows the image information W3, W4, W5, W6, W7, W8 of “Balance Check 1”, “Transaction Details 2”, “Transfer Service 3”, “Credit Card Service 4”, “Wealth Management Product 5”, “Speak to Customer Representative 6, etc. Finally, the user can press “Key/Button 1” of the physical key/button, or dictates “1” or “Balance Check”, and he or she can then hear the voice content of “Your account balance is xxxxxx dollars” on the fixed-line phone, and see the picture such as that in FIG. 5 through the internet TV at the same time, which shows the image information W9 of “Your account balance is xxxxxx dollars.”

It can be known thereby that the interactive system T in the present disclosure can achieve the following effects:
1. Better User Experience: The visual feedback mechanism can help users understand their choices and operation steps more clearly, thereby lowering the risks of users feeling confused or frustrated that could arise when they use traditional IVR systems.
2. Mitigation of User Misunderstanding: For users who have poor hearing or are not good at understanding voice instructions, when a voice instruction is not clear enough or has ambiguity, the visual feedback mechanism can provide additional picture assistance to help users to ascertain their choices.
3. Higher User Operation Efficiency Users can identify and choose the options they need more quickly, reducing operational errors and thus shortening operation time. Also, for users of advanced age, operating with telephone keys is more familiar and more convenient, as they can obtain corresponding picture information just by pressing keys.
4. Provision of Rich Content: The visual feedback mechanism can present images, motion images, text and other content on the second terminal device 21, allowing users to obtain information more clearly.
5. Lower Burden on Custom Service: When users can satisfy their needs faster and more intuitively, their need of being transferred to human custom service will be lowered, thereby lowering service providers' human resource costs.
6. Sales and Marketing Opportunities: The visual feedback mechanism can additionally display product images, promotional activities and other information on the picture(s) to increase sales opportunities.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An interactive system combining an automated voice mechanism with a visual feedback mechanism, comprising:
a first terminal device connectable to a public switched telephone network (PSTN) and having a user input interface, wherein the user input interface is configured to generate an input message according to operation of a user, and the input message includes a piece of input information;
a telecommunications server connectable to a voice database and configured to:
receive the input message sent from the first terminal device through the PSTN;
generate a processing message corresponding to the input message according to the input message, wherein the processing message includes a first identification code representing the first terminal device and a piece of interaction information corresponding to the input information;
retrieve at least one piece of pre-recorded voice fragment information from the voice database according to contents of the input message;
generate a voice feedback message according to the pre-recorded voice fragment information; and
send the voice feedback message to the first terminal device through the PSTN;
an information management server connectable to the telecommunications server and a user database, and configured to:
receive the processing message sent by the telecommunications server;
retrieve a piece of user information from the user database according to the first identification code in the processing message; and
generate a forward message, wherein the forward message includes the user information and the interaction information;
an information distribution server connectable to the information management server through an internet and configured to:
receive the forward message sent by the information management server; and
send a control message to a corresponding second terminal device according to the user information in the forward message, wherein the control message includes the interaction information;
the second terminal device configured to receive the control message through the internet from the information distribution server and generate a request message, wherein the request message includes a second identification code and the interaction information; and
a picture content management server connectable to a picture database and configured to:
receive the request message from the second terminal device through the internet;
retrieve at least one piece of picture information from the picture database according to the interaction information in the request message;
generate a picture feedback message according to the picture information; and
send the picture feedback message to the second terminal device through the internet.

2. The interactive system according to claim 1, further comprising a voice editing tool configured to edit pre-recorded voice fragment information in the voice database and input information corresponding to the pre-recorded voice fragment information in the voice database.

3. The interactive system according to claim 1, further comprising a picture editing tool configured to edit picture information in the picture database and interaction information corresponding to the picture information in the picture database.

4. The interactive system according to claim 1, wherein the first terminal device and the second terminal device are the same piece of equipment.

5. The interactive system according to claim 1, wherein the voice database is in the telecommunications server.

6. The interactive system according to claim 1, wherein the telecommunications server is installed with a voice recognition module.

7. The interactive system according to claim 1, wherein the picture database is in the picture content management server.

8. An interactive method of an interactive system combining an automated voice mechanism with a visual feedback mechanism, wherein the interactive system comprises a first terminal device, a telecommunications server, an information management server, an information distribution server, a second terminal device and a picture content management server, and the interactive method comprises steps of:
receiving, by the telecommunications server, an input message sent from the first terminal device through a public switched telephone network (PSTN), and generating, by the telecommunications server, a processing message corresponding to the input message, wherein the processing message includes a first identification code and a piece of interaction information;
retrieving, by the telecommunications server, at least one piece of pre-recorded voice fragment information from a voice database according to the processing message to generate a voice feedback message, sending, by the telecommunications server, the voice feedback message to the first terminal device through the PSTN, and sending, by the telecommunications server, the processing message to the information management server through an internet;
receiving, by the information management server, the processing message from the telecommunications server, retrieving, by the information management server, a piece of user information from a user database according to the first identification code in the processing message, generating, by the information management server, a forward message, and sending, by the information management server, the forward message to the information distribution server through the internet, wherein the forward message includes the user information and the interaction information;
receiving, by the information distribution server, the forward message sent from the information management server, generating, by the information distribution server, a control message according to the user information in the forward message, and sending, by the information distribution server, the control message to the second terminal device through the internet, wherein the control message includes the interaction information, and the second terminal device is configured to generate a request message according to the control message; and
receiving, by the picture content management server, the request message sent from the second terminal device through the internet, retrieving, by the picture content management server, at least one piece of picture information from a picture database according to the interaction information in the request message to generate a picture feedback message, and sending, by the picture content management server, the picture feedback message to the second terminal device through the internet.

9. The interactive method according to claim 8, wherein the first identification code corresponds to the first terminal device, the interaction information corresponds to a piece of input information in the processing message, and the input information is generated after a user operates the first terminal device.

10. The interactive method according to claim 8, wherein the first terminal device and the second terminal device are the same piece of equipment.

11. The interactive method according to claim 8, wherein the information management server stops generating and sending the forward message after the information management server does not retrieve the corresponding user information from the user database according to the first identification code in the processing message.
